(19) United States
(12) Patent Application Publication
(10) Pub. No.: US 2001/0024628 A1
(43) Pub. Date: Sep. 27, 2001

(54) Catalytic reactor

(76) Inventors: Patrick Bachinger, Lenningen (DE); Stefan Boneberg, Beuren (DE); Dietmar Heil, Schwendi (DE); Berthold Keppeler, Kirchheim/Tech (DE); Michael Schonert, Stuttgart (DE)

Correspondence Address: CROWELL & MORING LLP, Intellectual Property Group, P.O. Box 14300, Washington, DC, 20044-4300, US

(21) Appl. No.: 09/761,661

(22) Filed: Jan. 18, 2001

(30) Foreign Application Priority Data
Jan. 19, 2000 (DE) 100 02 024.0

(51) Int. Cl. B01J 8/04; B01J 8/00

(52) U.S. Cl. 422/192; 422/193; 422/197; 422/190

(57) ABSTRACT

A device for treating a medium in a fuel cell system has a reactor with a catalyst-containing region between a first part-chamber of the reactor and a second part-chamber of the reactor. The catalyst-containing region is arranged in the flow path of the medium, so that the medium flows through it. The first part-chamber is surrounded at least partially by the second part-chamber, and the catalyst-containing region is arranged as a partition between the first, inner part-chamber and the second, outer part-chamber. The partition is formed by a nonwoven provided with catalyst material.

### BACKGROUND AND SUMMARY OF THE INVENTION

This application claims the priority of German patent document 100 02 024.0, filed Jan. 19, 2000, the disclosure of which is expressly incorporated by reference herein.

The present invention relates to a device for treating a medium in a reactor having a catalyst-containing reaction chamber.

German patent document DE 195 26 886 C1 discloses a tubular reactor for methanol reforming, in which a medium (for example a gas mixture) is passed through catalyst-containing tubes and, in the process, is catalytically converted. A plurality of tubes are arranged parallel to one another to achieve the maximum possible conversion of the medium. The catalyst is usually arranged as a bed of material in a reactor of this type.

On object of the invention is to provide a reactor having a catalyst-containing reaction chamber which is compact, simple, space-saving and inexpensive to produce.

This and other objects and advantages are achieved by the catalytic reactor according to the invention, which has a catalyst-containing region between a first (inner) part-chamber, and a second (outer) part-chamber, the first part-chamber being surrounded, at least in certain regions, by the second part-chamber. The catalyst-containing region is formed by a nonwoven provided with catalyst material, which nonwoven forms a partition between the first part-chamber and the second part-chamber, in the region surrounded by the second part-chamber. The nonwoven is preferably metallic, particularly steel.

The reactor according to the invention is extremely compact, and is easy to produce. It also has a low mass and is inexpensive.

Other objects, advantages and novel features of the present invention will become apparent from the following detailed description of the invention when considered in conjunction with the accompanying drawings.

### BRIEF DESCRIPTION OF THE DRAWINGS

FIG. 1 is a diagrammatic depiction of a preferred embodiment of the invention, with a wound nonwoven;

FIGS. 2a, b and c are diagrammatic depictions of further preferred embodiments having a nonwoven of increased surface area; and

FIG. 3 shows the structure of a preferred embodiment of a reactor according to the invention.

### DETAILED DESCRIPTION OF THE DRAWINGS

It will be understood that the features mentioned above and those which are yet to be explained below can be used not only in the combination indicated in each case, but also in other combinations or on their own without departing from the scope of the present invention.

A reactor according to the invention is formed by a first part-chamber 2 and a second part-chamber 3, which are separated by a porous partition 6 arranged in the flow path of the medium. The medium flows into one part-chamber, passes through the partition, where it is catalytically converted, and then passes into the other part-chamber and is discharged from the reactor 1.

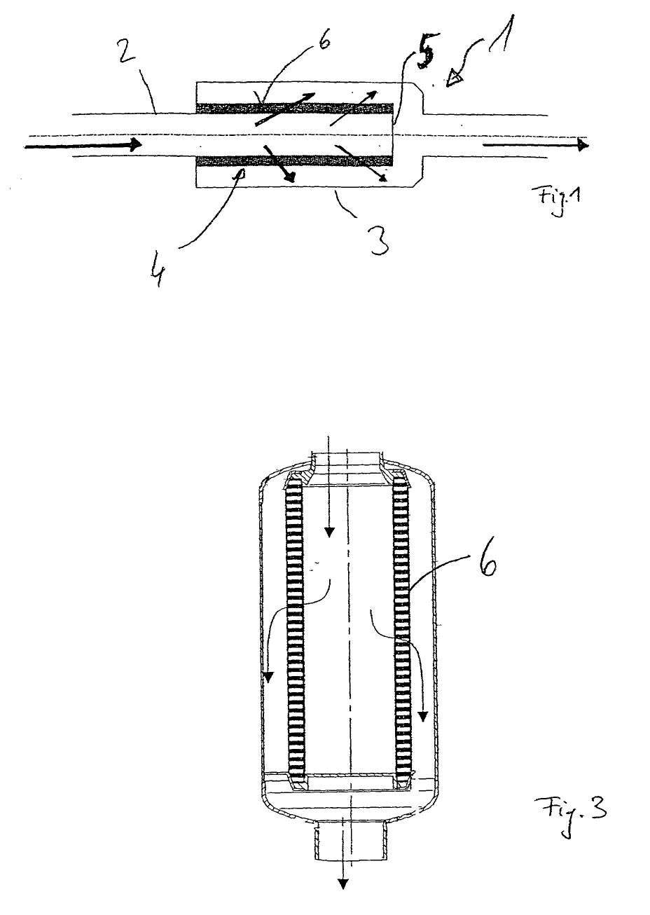

In the simplest case, the part-chambers 2, 3 may be coaxially arranged tubes, having any desired cross section, as illustrated in FIG. 1. A first tube as the first part-chamber 2 and a second tube as the second part-chamber 3 of a reactor 1 are arranged coaxially with respect to one another. The first tube 2 projects into the second tube 3 and at the projecting tube section 4 is closed off on one side with respect to the second tube 3 by means of a stopper 5.

The tube section 4 which projects into the second tube 3 has a wall 6 formed by a catalyst-containing, porous body. The wall 6 preferably consists of a wound, metallic nonwoven which is coated with catalyst material. It is also possible, however, for a porous body to be formed from a hollow ceramic part. The porous wall 6 is arranged in the flow path of a medium, which flows into the inner tube, and through the wall, substantially in the radial direction. As it passes transversely through the porous wall 6, the medium is catalytically converted or changed. A flow of medium is indicated by arrows. However, the flow may also be reversed, from the outside inwards.

As noted previously, a preferred porous body for forming a porous wall 6 is a nonwoven; it may be in the form of a fabric and formed from fibers which have been mixed or intertwined with one another or from meshes. Alternatively, it may consist of a porous foam. An advantage of such a composition is that nonwovens of this type are shapeable and can be used to match desired geometries particularly easily. Another important advantage is that nonwovens are easy to coat with catalyst material.

The nonwovens used should expediently have a high porosity together with a low fibre thickness. Nonwovens made from metal (especially, steel) whose individual fibers have been sintered together are advantageous. This is of benefit for the adhesion of the catalyst material to the fibers. Various known processes may be used for the coating process, for example dipping, spraying, etc.

A preferred porous body has pores with a mean diameter of at most 1 mm, and preferably less than 500 μm. The conversion of the medium is less satisfactory with a coarser pore structure than with a finer pore structure. A minimum advantageous pore size results, for example, from the tolerable pressure loss across the porous body.

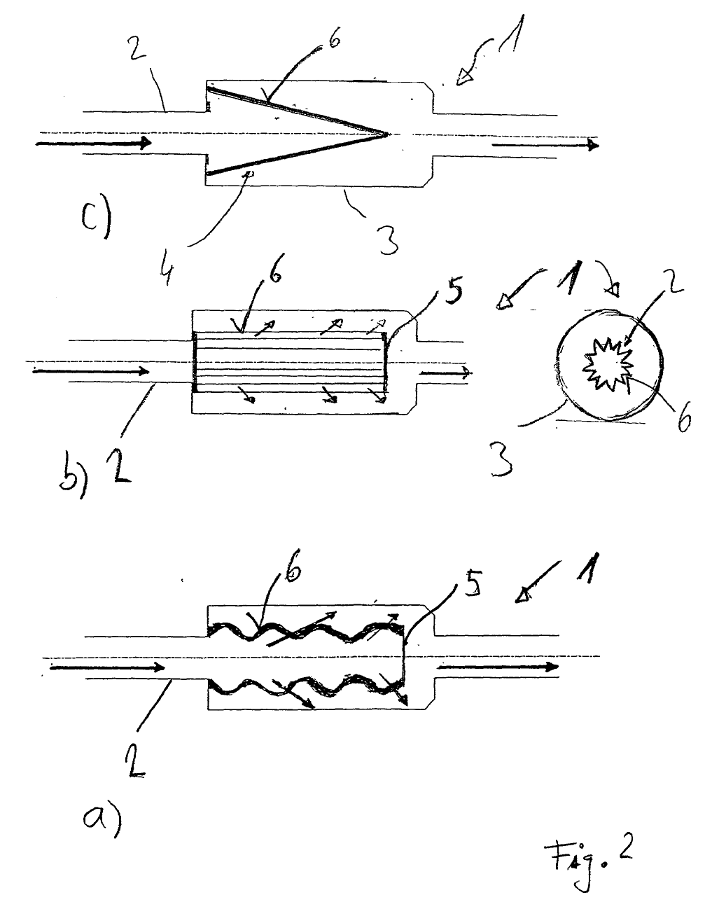

FIGS. 2a, b and c show further preferred embodiments of the reactor 1 according to the invention, which differ from the reactor in FIG. 1 in that they have a larger surface area of the wall 6. (Similar elements are denoted by the same reference numerals as those used in FIG. 1.)

In FIG. 2a, the substantially cylindrical wall 6 in the form of a nonwoven is substantially wavy or corrugated form, with the wave crests and wave troughs forming bulges perpendicular to the longitudinal extent of the tube. In the extended form, the length of the nonwoven would be greater than in the undulating or folded form. Therefore, the catalytic surface area of a nonwoven in wavy form is greater for the same length of tube section 4 than in the reactor shown in FIG. 1, in which a substantially smooth nonwoven is wound in order to form a partition 6 for the inner tube 2.

FIG. 2b illustrates another preferred embodiment in which the nonwoven (i.e., the wall 6) is designed in the form of a filter candle. The wall 6 is substantially cylindrical. In addition to the lateral side view, the figure also shows a plan view which illustrates the folding of the nonwoven. The nonwoven is folded in such a way that the circumference in the folded state is considerably larger than in the unfolded state.

FIG. 2c shows a further preferred embodiment, in which the wall 6 is of conical design and tapers in the direction of flow of the medium. The wall 6 may be smooth, as in FIG. 1, or in the form of a filter candle as shown in FIG. 2b, or may be undulating as shown in FIG. 2a.

Instead of the wound nonwovens, it is also possible for nonwovens to be designed as a honeycomb monolith, in which case honeycomb cells are alternately closed off on one side. This ensures a high porosity of the wall 6.

FIG. 3 shows the configuration of a preferred reactor 1 which is used for the combustion of residual methanol in the off-gas from a catalytic burner in a fuel cell system. The off-gas is to be converted as completely as possible.

The off-gas which is to be converted flows into the interior of the reactor. The off-gas usually contains unburnt hydrocarbons and hydrocarbons from combustion products in the off-gas. The hydrocarbons are to be catalytically burnt in the reactor, using the oxygen which is present in the off-gas. This takes place in the porous wall 6 when the off-gas penetrates through it into the outer circumferential region of the reactor vessel. The cleaned off-gas is then discharged from the outer circumference of the reactor vessel.

The reactor according to the invention is extremely compact; it is also of low mass, and is therefore particularly suitable for applications in which high dynamics and good cold-start properties are required, for example in fuel cell systems.

In turn, the nonwovens are easy to coat and exhibit good catalyst adhesion, which can be improved still further by sintering of the fibers of the nonwoven. At the same time, they can be deformed successfully both before and after the coating operation, so that they are easy to fit as the partition for the inner tube.

Based on the amount of catalyst used, the reactor, in its preferred use as a catalytic burner for off-gas cleaning in a fuel cell system, exhibits a higher level of hydrocarbon conversion than in the case of monoliths or bulk-bed reactors. The flow losses based on the hydrocarbon conversion level are also lower than in a bulk-bed reactor.

The risk of undesirable bypass streams of medium is lower than in monoliths or bulk-bed reactors. In addition, the efficiency of the catalyst material employed is improved, combined with a long service life of the reactor.

The device according to the invention can also be used for other types of reactor in the fuel cell system. A preferred reactor is a CO oxidation stage for the selective removal of CO in a hydrogen-containing gas mixture stream. A further preferred reactor is a reforming reactor for reforming a hydrogen-containing medium. For this purpose, it may be expedient for additional catalyst material to be arranged in the flow path of the medium, for example in the inner tube and/or also in the outer tube.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A reactor for treating a fluid medium, comprising:
a first, inner part-chamber;
a second, outer part-chamber; and
a catalyst-containing region arranged in the flow path of the medium, between the first and second part-chambers and having the medium flowing through it; wherein
the first part-chamber is surrounded at least partially by the second part-chamber;
the catalyst-containing region forms a partition between the first part-chamber and the second part-chamber; and
the partition comprises a nonwoven material with a catalyst material embedded therein.

2. The reactor according to claim 1, wherein:
the first and second part-chambers are formed by two coaxially arranged tubes;
an innermost of the two coaxial tubes is closed off with respect to the outer tube at an end of a tube section which projects into the outer tube; and
at least part of a circumference of the projecting tube section is formed by the nonwoven.

3. The reactor according to claim 1, wherein:
the first and second part-chambers are arranged coaxially with respect to one another;
the first part-chamber is designed in the form of a cone which projects into the second part-chamber; and
at least part of a circumference of the projecting tube section is formed by the nonwoven.

4. The reactor according to claim 1, wherein the first part-chamber forms a feed of the medium into the reactor.

5. The reactor according to claim 2, wherein the nonwoven has one of a folded and an undulating form.

6. The reactor according to claim 1, wherein the nonwoven comprises a honeycomb monolith with honeycomb cells that are closed on one side and have at least two nonwoven layers arranged one above the other, so that the honeycomb cells are arranged offset with respect to one another.

7. The reactor according to claim 1, wherein additional catalyst material is arranged in the first part-chamber.

8. A catalytic burner for off-gas cleaning, comprising a reactor having:
a first, inner part-chamber;
a second, outer part-chamber; and
a catalyst-containing region arranged in the flow path of the medium, between the first and second part-chambers and having the medium flowing through it; wherein
the first part-chamber is surrounded at least partially by the second part-chamber;
the catalyst-containing region forms a partition between the first part-chamber and the second part-chamber; and
the partition comprises a nonwoven material with a catalyst material embedded therein.

9. A CO oxidation stage for the selective removal of CO in a hydrogen-containing gas mixture stream, comprising a reactor having:
a first, inner part-chamber;
a second, outer part-chamber; and
a catalyst-containing region arranged in the flow path of the medium, between the first and second part-chambers and having the medium flowing through it; wherein
the first part-chamber is surrounded at least partially by the second part-chamber;
the catalyst-containing region forms a partition between the first part-chamber and the second part-chamber; and
the partition comprises a nonwoven material with a catalyst material embedded therein.

10. A reforming reactor for reforming a hydrogen-containing medium, comprising:
a first, inner part-chamber;
a second, outer part-chamber; and
a catalyst-containing region arranged in the flow path of the medium, between the first and second part-chambers and having the medium flowing through it; wherein
the first part-chamber is surrounded at least partially by the second part-chamber;
the catalyst-containing region forms a partition between the first part-chamber and the second part-chamber; and
the partition comprises a nonwoven material with a catalyst material embedded therein.
